(19) United States
(12) Patent Application Publication
(10) Pub. No.: US 2017/0156822 A1
(43) Pub. Date: Jun. 8, 2017

(54) ORTHODONTIC ASSEMBLY

(71) Applicant: METAL INDUSTRIES RESEARCH & DEVELOPMENT CENTRE, Kaohsiung (TW)

(72) Inventors: Chien-Hung Yu, Taichung City (TW); Wei-Hung Shih, Kaohsiung City (TW); Wei-Te Wu, Taichung City (TW); Yen-Chun Chen, Kaohsiung City (TW); Tsung-Chih Yu, Tainan City (TW); Ho-Chung Fu, Kaohsiung City (TW)

(21) Appl. No.: 14/979,552

(22) Filed: Dec. 28, 2015

(30) Foreign Application Priority Data
Dec. 8, 2015 (TW) 104141117

(51) Int. Cl. A61C 7/14; A61C 7/12; A61C 7/22

(52) U.S. Cl. CPC A61C 7/143; A61C 7/22; A61C 7/125

(57) ABSTRACT

An orthodontic bracket and an orthodontic assembly are provided. The orthodontic bracket includes a bottom base, a first sidewall, a second sidewall and two blocks. The bottom base has a first surface and a second surface opposite to each other. The first sidewall is disposed on the first surface. The second sidewall is disposed on the first surface and is opposite to the first sidewall. The blocks are disposed on the first surface between the first sidewall and the second sidewall. A bending space is defined and formed between the blocks, a first path is defined and formed between the first sidewall and the blocks, and a second path is defined and formed between the second sidewall and the blocks. An orthodontic wire is configured to be disposed in the first path or the second path, or to extend through the first path, the bending space and the second path.

### RELATED APPLICATIONS

This application claims priority to Taiwan Application Serial Number 104141117, filed Dec. 8, 2015, which is herein incorporated by reference.

### BACKGROUND

### Field of Invention

The present invention relates to an orthodontic bracket and an orthodontic assembly.

### Description of Related Art

An orthodontic treatment is to guide a patient's teeth to proper positions through a pulling force from an orthodontic wire. During the orthodontic treatment, a dentist first attaches several orthodontic brackets to the patient's teeth surfaces, and then engages the orthodontic wire in each orthodontic bracket to form a predetermined track, thereby guiding the patient's teeth to right positions.

However, common orthodontic brackets merely can fix the orthodontic wire in one identical direction, but cannot finely adjust the direction of the orthodontic wire to fit different teeth shapes. Another orthodontic bracket has a function of adjusting the position of the orthodontic wire, but its structure is too complicated, which not only is difficult to be fabricated but also is likely to damage the patient's oral mucosa.

### SUMMARY

One object of the present invention is to provide an orthodontic bracket for a dentist to adjust an orthodontic wire to different slopes or curvatures according to actual requirements, thereby fitting various occlusion shapes.

According to the aforementioned object, an orthodontic bracket is provided. The orthodontic bracket includes a bottom base, a first sidewall, a second sidewall and two blocks. The bottom base has a first surface and a second surface opposite to the first surface. The first sidewall is disposed on the first surface. The second sidewall is disposed on the first surface, in which the second sidewall is opposite to the first sidewall. The blocks are disposed on the first surface between the first sidewall and the second sidewall, in which a bending space is defined and formed between the blocks, a first path is defined and formed between the first sidewall and the blocks, and a second path is defined and formed between the second sidewall and the blocks. An orthodontic wire is configured to be disposed in the first path or the second path, or to extend through the first path, the bending space and the second path.

According to an embodiment of the present invention, the blocks have substantially the same sizes, and a width of the first path is substantially equal to a width of the second path.

According to an embodiment of the present invention, the blocks have different sizes. A width of one end of the first path is greater than a width of the other end of the first path, and a width of one end of the second path is greater than a width of the other end of the second path.

According to an embodiment of the present invention, the blocks have substantially the same sizes, and one of the blocks is located closer to the first sidewall than the other one of the blocks is. A width of one end of the first path is greater than a width of the other end of the first path, and a width of one end of the second path is greater than a width of the other end of the second path.

According to the aforementioned object, an orthodontic assembly is provided. The orthodontic assembly includes an orthodontic bracket and a cap. The orthodontic bracket includes a bottom base, a first sidewall, a second sidewall and two blocks. The bottom base has a first surface and a second surface opposite to the first surface. The first sidewall is disposed on the first surface. The second sidewall is disposed on the first surface, in which the second sidewall is opposite to the first sidewall. The blocks are disposed on the first surface between the first sidewall and the second sidewall, in which a bending space is defined and formed between the blocks, a first path is defined and formed between the first sidewall and the blocks, and a second path is defined and formed between the second sidewall and the blocks. An orthodontic wire is configured to be disposed in the first path or the second path, or to extend through the first path, the bending space and the second path. The cap covers the orthodontic bracket, in which the cap is engaged with the orthodontic bracket.

According to an embodiment of the present invention, the blocks have substantially the same sizes, and a width of the first path is substantially equal to a width of the second path.

According to an embodiment of the present invention, the blocks have different sizes. A width of one end of the first path is greater than a width of the other end of the first path, and a width of one end of the second path is greater than a width of the other end of the second path.

According to an embodiment of the present invention, the blocks have substantially the same sizes, and one of the blocks is located closer to the first sidewall than the other one of the blocks is. A width of one end of the first path is greater than a width of the other end of the first path, and a width of one end of the second path is greater than a width of the other end of the second path.

According to an embodiment of the present invention, the cap includes a base, a first engaging portion and a second engaging portion respectively connected to the base. The first engaging portion is correspondingly engaged in the first path, and the second engaging portion is correspondingly engaged in the second path.

According to the aforementioned object, another orthodontic bracket is provided. The orthodontic bracket includes a bottom base, a first sidewall, a second sidewall and only two blocks. The bottom base has a first surface and a second surface opposite to the first surface. The first sidewall is disposed on the first surface. The second sidewall is disposed on the first surface, in which the second sidewall is opposite to the first sidewall. The only two blocks are disposed on the first surface between the first sidewall and the second sidewall, in which a bending space is defined and formed between the only two blocks, a first path is defined and formed between the first sidewall and the only two blocks, and a second path is defined and formed between the second sidewall and the only two blocks. An orthodontic wire is configured to be disposed in the first path or the second path, or to extend through the first path, the bending space and the second path.

According to an embodiment of the present invention, the only two blocks have substantially the same sizes, and a width of the first path is substantially equal to a width of the second path.

According to an embodiment of the present invention, the only two blocks have different sizes. A width of one end of the first path is greater than a width of the other end of the first path, and a width of one end of the second path is greater than a width of the other end of the second path.

According to an embodiment of the present invention, the only two blocks have substantially the same sizes, and one of the only two blocks is located closer to the first sidewall than the other one of the only two blocks is. A width of one end of the first path is greater than a width of the other end of the first path, and a width of one end of the second path is greater than a width of the other end of the second path.

It can be known from the aforementioned embodiments of the present invention that, the orthodontic wire can be adjusted to different slopes or curvatures by changing the positions or sizes of the blocks of the orthodontic bracket. Therefore, the dentist can use different orthodontic brackets having blocks with different positions or sizes to control the shape of the orthodontic wire, so as to fit various occlusion shapes.

In addition, after being fixed on the orthodontic bracket, the orthodontic wire can be pressed and fixed by engaging the cap with the orthodontic bracket.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic structural diagram showing an orthodontic bracket in accordance with a first embodiment of the present invention;

FIG. 2A-FIG. 2D are schematic diagrams showing the orthodontic bracket in different application states in accordance with the first embodiment of the present invention;

FIG. 3 is a schematic diagram showing the orthodontic bracket attached to a patient's teeth in accordance with the first embodiment of the present invention;

FIG. 4A and FIG. 4B are schematic diagrams showing an orthodontic bracket in different application states in accordance with a second embodiment of the present invention;

FIG. 5A-FIG. 5D are schematic diagrams showing an orthodontic bracket in different application states in accordance with a third embodiment of the present invention;

FIG. 6A is a schematic structural diagram showing an orthodontic assembly in accordance with an embodiment of the present invention;

FIG. 6B is a schematic side view showing the orthodontic assembly in accordance with an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

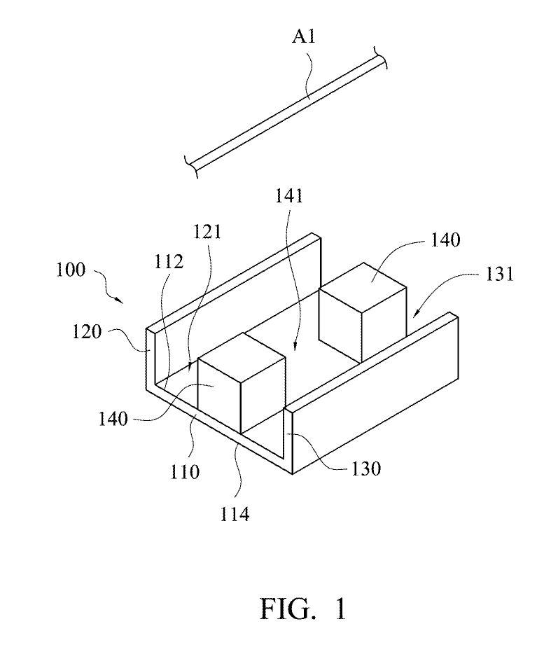

Referring to FIG. 1, FIG. 1 is a schematic structural diagram showing an orthodontic bracket 100 in accordance with a first embodiment of the present invention. The orthodontic bracket 100 of the present embodiment includes a bottom base 110, a first sidewall 120, a second sidewall 130 and two blocks 140. The bottom base 110 has a first surface 112 and a second surface 114 opposite to the first surface 112. The second surface 114 is used to be attached to a surface of a patient's tooth. As shown in FIG. 1, the first sidewall 120 and the second sidewall 130 are respectively disposed on the first surface 112 near two opposite sides of the first surface 112. In other words, the bottom base 110, the first sidewall 120 and the second sidewall 130 are collectively formed a U-like shape from a side view.

Referring to FIG. 1 again, the blocks 140 are disposed on the first surface 112 and are located between the first sidewall 120 and the second sidewall 130. In the present embodiment, the number of the blocks 140 is 2, and both of the blocks 140 have substantially the same sizes, but embodiments of the present invention are not limited thereto. As shown in FIG. 1, a first path 121 is defined and formed between the first sidewall 120 and the blocks 140, and a second path 131 is defined and formed between the second sidewall 130 and the blocks 140. Moreover, a bending space 141 is defined and formed between the two blocks 140. Therefore, after fixing the orthodontic bracket 100 onto the surface of the patient's tooth, an orthodontic wire A1 can be disposed in the first path 121 or the second path 131, or extend through the first path 121, the bending space 141 and the second path 131 according to the patient's teeth shapes. It is noted that, the number of the blocks can be only two or more than two.

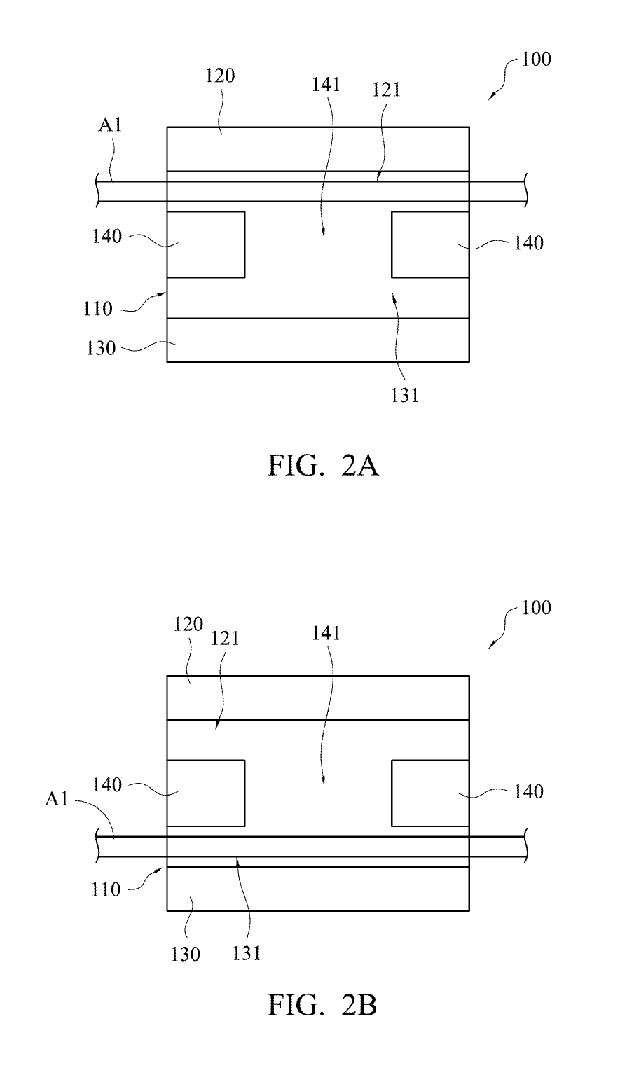

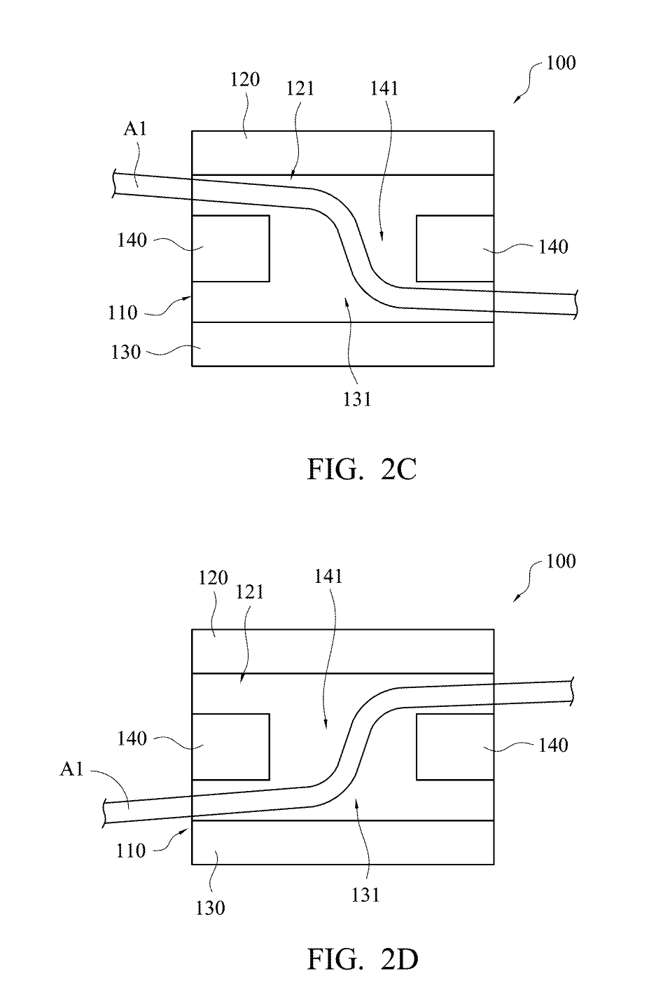

Simultaneously referring to FIG. 2A-FIG. 2D, FIG. 2A-FIG. 2D are schematic diagrams showing the orthodontic bracket 100 in different application states in accordance with the first embodiment of the present invention. As shown in FIG. 2A and FIG. 2B, the orthodontic wire A1 can be directly disposed in the first path 121 or the second path 131. As shown in FIG. 2C and FIG. 2D, the orthodontic wire A1 extends through the first path 121, the bending space 141 and the second path 131. In other words, one portion of the orthodontic wire A1 is located in the first path 121, another portion of the orthodontic wire A1 is bended in the bending space 141, and the other portion of the orthodontic wire A1 is located in the second path 131.

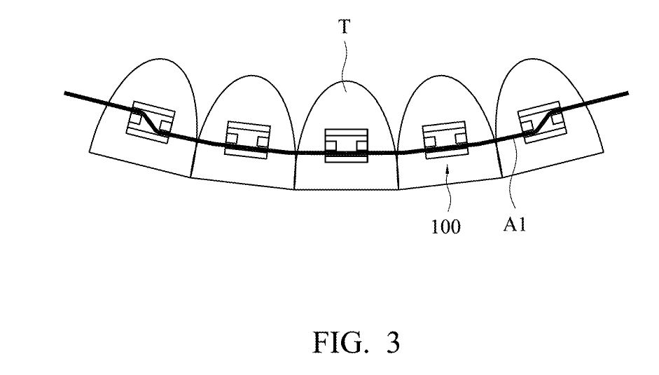

Referring to FIG. 3, FIG. 3 is a schematic diagram showing the orthodontic bracket 100 attached to a patient's teeth in accordance with the first embodiment of the present invention. It is noted that the orthodontic wire A1 in FIG. 3 is shown in a thicker dark line. As shown in FIG. 3, a dentist can first fix several orthodontic brackets 100 onto some of teeth T, and then engage the orthodontic wire A1 onto each orthodontic bracket 100 according to requirements of different teeth shapes, so as to enable the teeth T to be pulled by the orthodontic wire A1, thus moving the teeth T to their correct positions. It is noted that the application of the orthodontic bracket 100 shown in FIG. 3 is merely used as an example for explanation, and embodiments of the present invention are not limited thereto.

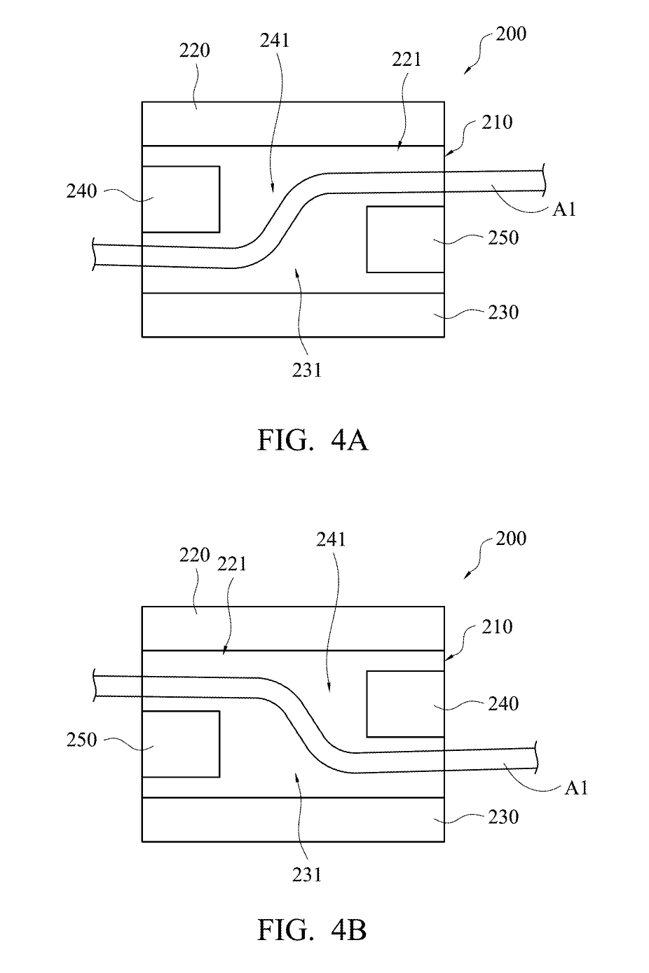

It is noted that, in the orthodontic bracket 100, a distance between the first sidewall 120 and the blocks 140 is substantially equal to a distance between the second sidewall 130 and the blocks 140, but embodiments of the present invention are not limited thereto. In other embodiments, the blocks can also be disposed on different locations. Referring to FIG. 4A and FIG. 4B, FIG. 4A and FIG. 4B are schematic diagrams showing an orthodontic bracket 200 in different application states in accordance with a second embodiment of the present invention. In the present embodiment, the orthodontic bracket 200 includes a bottom base 210, a first sidewall 220, a second sidewall 230 and two blocks 240 and 250. The first sidewall 220 and the second sidewall 230 are disposed on two opposite sides of the bottom base 210, and the blocks 240 and 250 are disposed between the first sidewall 220 and the second sidewall 230.

As shown in FIG. 4A and FIG. 4B, a first path 221 is defined and formed between the first sidewall 220 and the blocks 240 and 250, a second path 231 is defined and formed between the second sidewall 230 and the blocks 240 and 250, and a bending space 241 is defined and formed between the block 240 and block 250. In the present embodiment, the block 240 and the block 250 have substantially the same sizes, in which the block 240 is located near the first sidewall 220, and the block 250 is located near the second sidewall 230. Therefore, a width of one end near the block 250 of the first path 221 is greater than a width of the other end near the block 240 of the first path 221, and a width of one end near the block 240 of the second path 231 is greater than a width of the other end near the block 250 of the second path 231. Therefore, when being fixed on the orthodontic bracket 200, the orthodontic wire A1 can be bent to have any required curvatures according to the locations of the blocks 240 and 250.

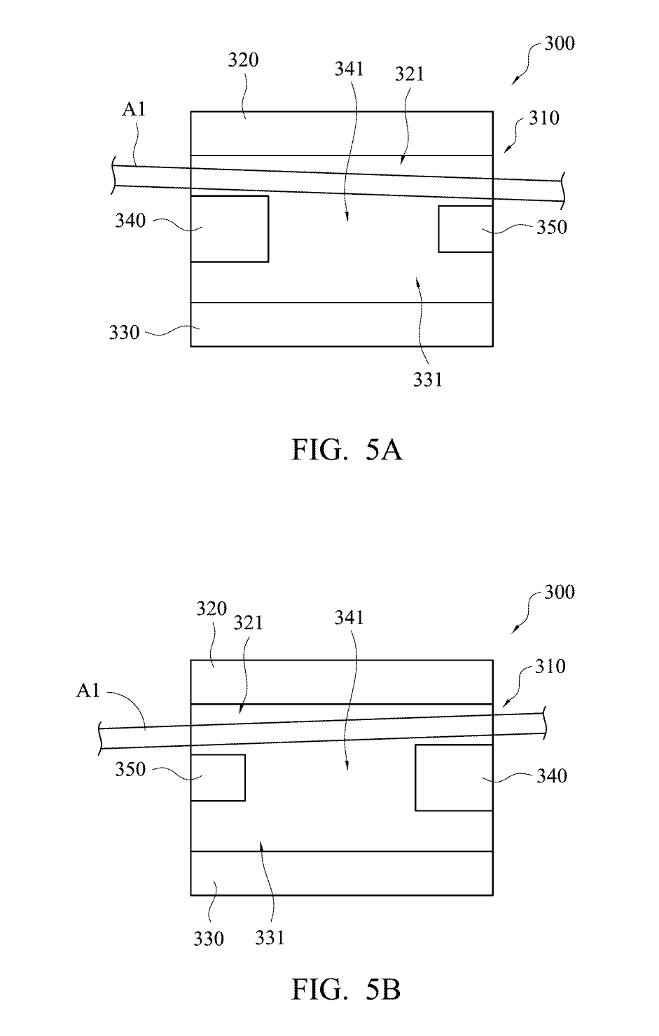

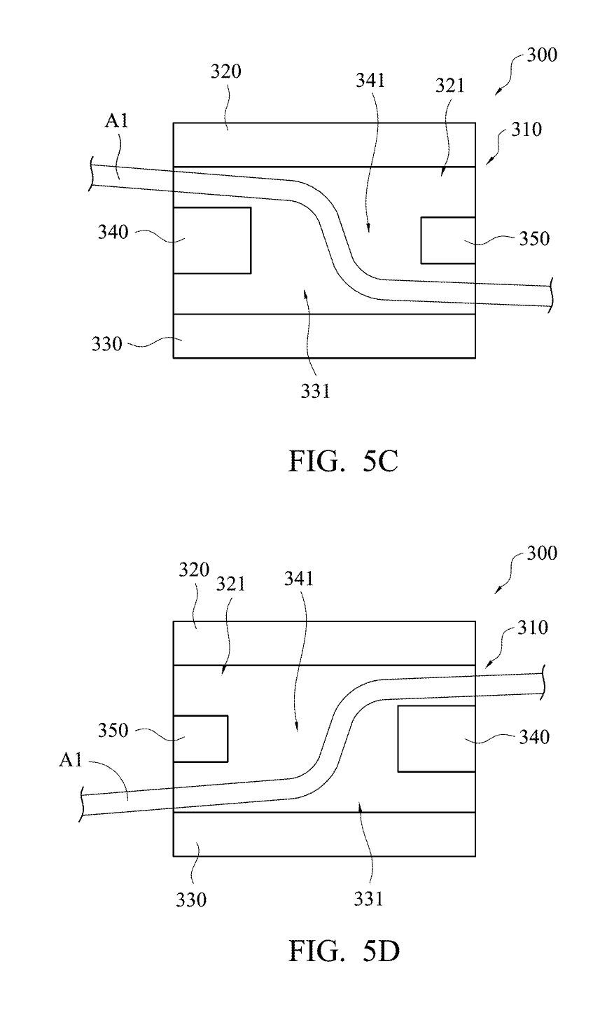

It is noted that, in the orthodontic bracket 200 of the aforementioned embodiment, the block 240 and the block 250 have substantially the same sizes, but embodiments of the present invention are not limited thereto. In other embodiments, the blocks can have different sizes. Referring to FIG. 5A-FIG. 5D, FIG. 5A-FIG. 5D are schematic diagrams showing an orthodontic bracket 300 in different application states in accordance with a third embodiment of the present invention. In the present embodiment, the orthodontic bracket 300 includes a bottom base 310, a first sidewall 320, a second sidewall 330 and two blocks 340 and 350. The first sidewall 320 and the second sidewall 330 are disposed on two opposite sides of the bottom base 310, and the blocks 340 and 350 are disposed between the first sidewall 320 and the second sidewall 330.

As shown in FIG. 5A-FIG. 5D, a first path 321 is defined and formed between the first sidewall 320 and the blocks 340 and 350, a second path 331 is defined and formed between the second sidewall 330 and the blocks 340 and 350, and a bending space 341 is defined and formed between the block 340 and block 350. In the present embodiment, the block 340 and the block 350 have different sizes, in which a size of the block 340 is greater than a size of the block 350. Therefore, a width of one end near the block 350 of the first path 321 is greater than a width of the other end near the block 340 of the first path 321, and a width of one end near the block 350 of the second path 331 is greater than a width of the other end near the block 340 of the second path 331. Therefore, as shown in FIG. 5A and FIG. 5B, when being disposed in the first path 321 or the second path 331 as well as abutting against the blocks 340 and 350, the orthodontic wire A1 is inclined. In addition, the orthodontic wire A1 can extend through the first path 321, the bending space 341 and the second path 331, and is bent to have different curvatures.

From the embodiments, it can be known that, when the blocks are disposed at different locations, or have different sizes, the orthodontic wire A1 can be bent to have different inclinations or curvatures accordingly. Therefore, the dentist can precisely adjust and control the bending shape of the orthodontic wire A1 to collaborate with different orthodontic brackets, such as the orthodontic bracket 100, 200 or 300.

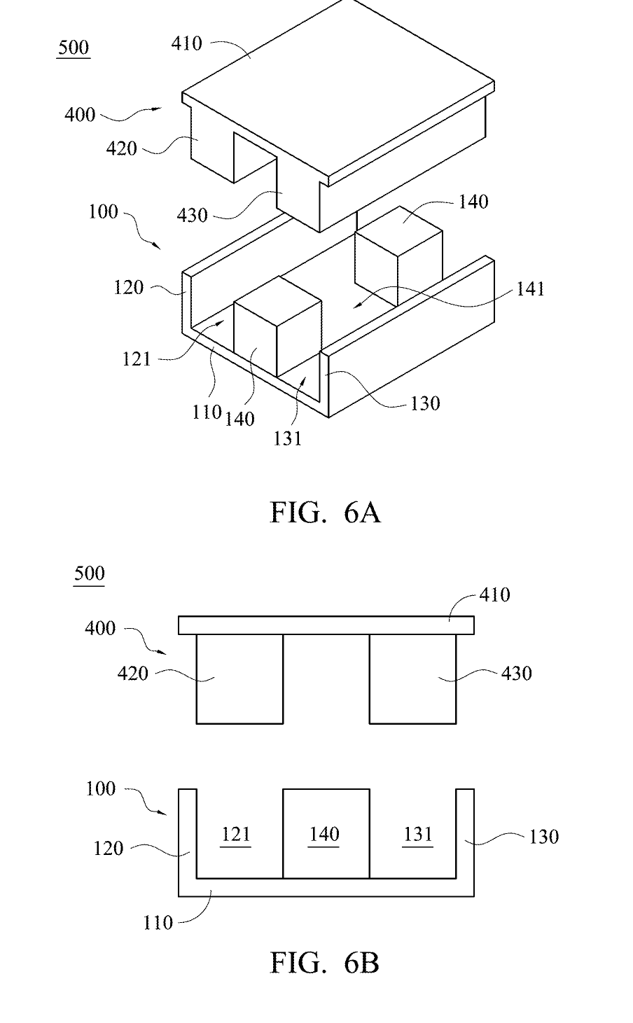

Referring to FIG. 6A and FIG. 6B, FIG. 6A and FIG. 6B are a schematic structural diagram and a schematic side view showing an orthodontic assembly 500 in accordance with an embodiment of the present invention. The orthodontic assembly 500 of the present embodiment includes the orthodontic bracket 100 as shown in FIG. 1 to FIG. 2D and a cap 400. The cap 400 is used to be engaged with the orthodontic bracket 100. As shown in FIG. 6A and FIG. 6B, the cap 400 includes a base 410, a first engaging portion 420 and a second engaging portion 430. The first engaging portion 420 and the second engaging portion 430 are respectively connected to the base 410, and the first engaging portion 420 and the second engaging portion 430 are respectively located corresponding to the first path 121 and the second path 131. Moreover, the first engaging portion 420 is correspondingly engaged in the first path 121, and the second engaging portion 430 is correspondingly engaged in the second path 131. Therefore, when disposed on the orthodontic bracket 100, the orthodontic wire A1 can be pressed by the first engaging portion 420 and the second engaging portion 430 of the cap 400, so that the orthodontic wire A1 can be firmly fixed on the orthodontic bracket 100.

Referring to FIG. 6A and FIG. 6B again, in some embodiments, the cap 400 and/or the orthodontic bracket 100 can be made of a polymer material or a biocompatible elastic material. Therefore, the cap 400 can be tightly engaged with the orthodontic bracket 100 due to its elasticity, thus firmly fixing the orthodontic wire A1 on the orthodontic bracket 100. It is noted that the orthodontic bracket 100 shown in FIG. 1 to FIG. 2D applied to the orthodontic assembly 500 is merely used as an example for explanation, and other embodiments of the present invention are not limited thereto. Other orthodontic brackets, such as the orthodontic bracket 200 and 300 can also be applied to the orthodontic assembly to achieve the same effect as described above, which will not be described herein.

It can be known from the aforementioned embodiments of the present invention that, the orthodontic wire can be adjusted to different slopes or curvatures by changing the positions or sizes of the blocks of the orthodontic bracket. Therefore, the dentist can use different orthodontic brackets having blocks with different positions or sizes to control the shape of the orthodontic wire, so as to fit various dental occlusion shapes.

In addition, after being fixed on the orthodontic bracket, the orthodontic wire can be pressed and fixed by engaging the cap with the orthodontic bracket.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1-4. (canceled)

5. An orthodontic assembly, comprising: an orthodontic bracket, comprising:
a bottom base having a first surface and a second surface opposite to the first surface, wherein the first surface has a first side edge and a second side edge vertical to the first side edge;
a first sidewall disposed on the first surface along the side edge;
second sidewall disposed on the first surface along the first side edge, wherein the second sidewall is seperated from the first sidewall at a distance which is parallel to the second side edge; and
two blocks disposed on the first surface between the first sidewall and the second sidewall, wherein a bending space is defined and farmed between the blocks, a first path is defined and formed between the first sidewall and the blocks, and a second path is defined and formed between the second sidewall and the blocks;
wherein each of the first sidewall and the second sidewall has a length parallel to the first side edge, and the blocks respectively have outer surfaces, and a distance parallel to the first side edge between the outer surfaces of the respective blocks is equal to the length of the first sidewall and the second sidewall;
wherein an orthodontic wire is configured to be disposed in the first path or the second path, or to extend through the first path, the bending space and the second path; and
a cap covering the orthodontic bracket, wherein the cap engaged with the orthodontic bracket.

6. The orthodontic assembly of claim 5, wherein the blocks have substantially the same sizes, and a width of the first path is substantially equal to a width of the second path.

7. The orthodontic assembly of claim 5, wherein
the blocks have different sizes;
a width of one end of the first path is greater than a width of the other end of the first path; and
a width of one end of the second path is greater than a width of the other end of the second path.

8. The orthodontic assembly of claim 5, wherein
the blocks have substantially the same sizes, and one of the blocks is located closer to the first sidewall than the other one of the blocks is;
a width of one end of the first path is greater than a width of the other end of the first path; and
a width of one end of the second path is greater than a width of the other end of the second path.

9. The orthodontic assembly of claim 5, wherein the cap comprises a base, a first engaging portion and a second engaging portion respectively connected to the base, the first engaging portion is correspondingly engaged in the first path, and the second engaging portion is correspondingly engaged in the second path.

10-13. (canceled)
